(19) United States
(12) Patent Application Publication
(10) Pub. No.: US 2023/0228853 A1
(43) Pub. Date: Jul. 20, 2023

(54) PROGRAMMABLE POWER MODULE FOR LIDAR RECEIVER CHAIN

(71) Applicant: Analog Devices, Inc., Wilmington, DE (US)

(72) Inventor: Noe QUINTERO, Fremont, CA (US)

(21) Appl. No.: 18/154,688

(22) Filed: Jan. 13, 2023

Related U.S. Application Data
(60) Provisional application No. 63/299,797, filed on Jan. 14, 2022.

(51) Int. Cl. G01S 7/4863; G01S 7/481

(52) U.S. Cl. CPC G01S 7/4863; G01S 7/4816

(57) ABSTRACT

Technologies described herein include a programmable power module for a light detection and ranging (LiDAR) system. In some aspects, the programmable power module includes circuitry that supplies a bias voltage to a photodetector array, and a programmable interface comprising a serial interface and multiple configurable ports. Each one of the multiple configurable ports is configured as one of a digital-to-analog converter (DAC) output port, an analog-to-digital converter (ADC) input port, a digital output port, or a digital input port. The serial interface can be configured to receive program code defining a control voltage that causes the circuitry to set the bias voltage. A first configurable port of the multiple configurable ports can be connected to the circuitry and can be configured as a first DAC output port that outputs the control voltage to the circuitry.

### CROSS-REFERENCE TO RELATED APPLICATION

This application claims the benefit of and priority to U.S. Provisional Patent Application No. 63/299,797, filed Jan. 14, 2022, the contents of which application are hereby incorporated by reference herein in their entirety.

### BACKGROUND

Light detection and ranging (LiDAR) is a sensing technique for estimating distance to a remote object by using pulsed laser light. LiDAR can be used to perform ranging or to create depth maps of a scene of interest. LiDAR has aerial and terrestrial applications, including automotive applications involving autonomous driving or other types of autonomous locomotion.

A system that implements LiDAR, referred to as a LiDAR system, includes a laser device, a scanner device, a timing device, and a processor. The LiDAR system can be separated into a LiDAR transmitter subsystem, a LiDAR receiver subsystem, and the processor. The LiDAR receiver subsystem (also referred to as LiDAR receiver chain) includes photodetectors that convert received light to current. The photodetectors can include avalanche photodiodes (APDs). The APDs exhibit a robust current gain, which makes them desirable as photodetectors in high-end LiDAR systems. The current gain, however, changes significantly and non-linearly with bias voltage and temperature. That current gain behavior combined with large temperature coefficients of typical APDs makes it difficult to maintain a stable, desired level of current gain during operation of the LiDAR receiver subsystem. Further, the LiDAR receiver subsystem also includes an amplifier device that converts a current received from the photodetectors to voltage. In typical situations where ambient light is present, the robust current gain of APDs can saturate the inputs to transimpedance amplifiers (TIAs) that may be present in the amplifier device. Such saturation can exacerbate the difficulty in maintaining a stable, desired level of current gain in the LiDAR receiver subsystem.

Therefore, much remains to be improved in technologies for controllably biasing photodetectors and adjusting operation of amplifier devices within a LiDAR receiver subsystem.

### SUMMARY

One aspect includes a device that includes circuitry that supplies a bias voltage to a photodetector array; and a programmable interface comprising a serial interface and multiple configurable ports. Each one of the multiple configurable ports is configured as one of a digital-to-analog converter (DAC) output port, an analog-to-digital converter (ADC) input port, a digital output port, or a digital input port. The serial interface can be configured to receive program code defining a control voltage that causes the circuitry to supply the bias voltage. A first configurable port of the multiple configurable ports is connected to the circuitry and is configured as a first DAC output port that outputs the control voltage to the power module.

Another aspect includes a system includes a power module having circuitry that supplies a bias voltage; and a programmable interface comprising a serial interface and multiple configurable ports. Each one of the multiple configurable ports is configured as one of a digital-to-analog converter (DAC) output port, an analog-to-digital converter (ADC) input port, a digital output port, or a digital input port. The system also includes a photodetector array coupled to the power module and configured to receive the bias voltage; and an amplifier device coupled to the photodetector array.

Additional aspects include apparatuses having various functional purposes involving navigating, using LiDAR data, within a space having obstacles, where the apparatuses include a LiDAR receiver subsystem having a power module as is described herein.

This Summary is not intended to emphasize any particular aspects of the technologies of this disclosure. Nor is it intended to limit in any way the scope of such technologies. This Summary simply covers a few of the many aspects of this disclosure as a straightforward introduction to the more detailed description that follows.

### BRIEF DESCRIPTION OF THE DRAWINGS

The accompanying drawings form part of the disclosure and are incorporated into the subject specification. The drawings illustrate example aspects of the disclosure and, in conjunction with the following detailed description, serve to explain at least in part various principles, features, or aspects of the disclosure. Some aspects of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 is a schematic block diagram of an example of a LiDAR receiver system including a programmable power module, in accordance with one or more aspects of this disclosure.

FIG. 2 is a schematic block diagram of an example of programmable interface, in accordance with one or more aspects of this disclosure.

FIG. 3 is a schematic block diagram of an example of a system including a programmable power module for a LiDAR receiver subsystem, in accordance with one or more aspects of this disclosure.

FIG. 4 is a schematic diagram of an example of a programmable power module integrated with a LiDAR receiver subsystem, in accordance with one or more aspects of this disclosure.

FIG. 5 is a schematic block diagram of an example of a programmable power module coupled to an APD array, in accordance with one or more aspects of this disclosure.

FIG. 6 is a schematic block diagram of the programmable power module coupled to an APD array, in accordance with one or more aspects of this disclosure.

FIG. 7 is a schematic block diagram of an apparatus that includes a LiDAR receiver subsystem biased by programmable power module in accordance with one or more aspects of this disclosure.

### DETAILED DESCRIPTION

The present disclosure recognizes and addresses, among other technical challenges, the issue of controllably biasing photodetectors and adjusting operation of amplifier devices within a LiDAR receiver subsystem. Photodetectors used in some LiDAR receiver subsystems include APDs because APDs exhibit a robust current gain, and therefore, can be appropriate photodetectors in automotive applications or other high-end LiDAR systems. The current gain, however, changes significantly and non-linearly with bias voltage applied to the APDs and temperature of the APDs. Additionally, APDs typically have large temperature coefficients. As a result, biasing APDs in a stable manner at a desired level of current gain can be challenging during operation of a LiDAR receiver subsystem. Further, the LiDAR receiver subsystem also can include an amplifier device that converts a current received from APDs to voltage. Ambient light combined with the robust current gain of the APDs can saturate the inputs to TIAs that may constitute the amplifier device. Such saturation can exacerbate the difficulty in maintaining a stable, desired level of current gain in the LiDAR receiver subsystem. As a result, existing technologies rely on separate circuitry to control bias of the APDs and operational attributes of such an amplifier device. This may yield large LiDAR receiver subsystems that are device-specific and cannot be forward compatible. Undesirable large footprints also can be a result of using separate circuitry for such purposes.

As is described in greater detail below, the present disclosure provides techniques, devices, and systems for the integration of a LiDAR receiver subsystem and a source of bias voltage. Aspects of the disclosure include a programmable power module that has power supply circuitry and a programmable interface. The power supply circuitry can supply a negative high voltage (HV) that can be used to bias an array of photodetectors included in the LiDAR receiver subsystem. The programmable interface includes multiple configurable input/output (I/O) ports. Each one of the multiple configurable I/O ports can be configured to output or receive a signal that is an analog or a digital signal. The programmable interface permits adjusting the negative high voltage based on various operating conditions of the array of photodetectors. One of such operating conditions is temperature. As such, the programmable interface can obtain an analog signal indicative of a temperature of the array of photodetectors. Based on the temperature, the programmable interface can permit adjusting the voltage that the power supply circuitry supplies to the array of photodetectors. Accordingly, the programable power module can permit maintaining a current gain of the array of photodetectors at a desired level despite changes in temperature. Even in implementations where the array of photodetectors includes an array of APDs, and, thus, changes in current gain are non-linear in temperature, the programmable power module can permit maintaining a desired level of current gain.

In alternative or additional aspects, the programmable interface also can permit adjusting various operational attributes of an amplifier device used along with the array of photodetectors within a LiDAR receiver subsystem. To that end, the programmable interface may include multiple configurable I/O ports that can configure one or more pins of the amplifier device at respective desired voltages. Each one of the respective desired voltages in turn can configure an operational attribute of the amplifier device. In some cases, the amplifier device includes transimpedance amplifiers (TIAs) and the operating attributes include, for example, offset, tilt, clamping condition, voltage gain, or a combination thereof.

Further, in some alternative or additional aspects, the programmable power module can sense current and voltage. More specifically, the programmable power module can sense current that is drawn from the array of photodetectors within a LiDAR receiver subsystem. The programmable power module also can sense voltage supplied to the array of photodetectors. By sensing such voltage and current, the programmable power module can permit assessing an operating state (colloquially referred to as “health”) of the array of photodetectors. The programmable power module, via the programmable interface, also can configure a current limit for the array of photodetectors. Thus, the programmable power module can permit protecting such an array from damage.

In alternative or additional aspects, the programmable power modules of this disclosure can be integrated into a LiDAR receiver system. The programmable power module can be programmed by a processor, such as a microcontroller or another type of processor. To that end, the programmable interface can include a serial bus and logic, and the processor is functionally coupled to that serial interface. The processor can send, via the serial bus, program code to the programmable interface. Program code also can be referred to as programming instructions. The program code can define a datum or a code instruction, and can cause either configuration of a configurable I/O port or programming of an output analog signal from the configuration I/O port. The processor also can receive data defining a value of an analog signal obtained by the programmable interface. Receiving such data can be referred to as readout operation (or readout). Read and write operations afforded by the serial bus can permit sending and receiving program code, respectively. It is noted that the processor need not be dedicated to programming a programmable power module. In some cases, the processor also can be utilized in the operation of the LiDAR system

In alternative or additional aspects, the programmable power module also can sense temperature of the module itself. To that point, the programmable power module can include a temperature indicator that can measure temperature of a die where the programmable power module is packaged. The programmable power module can power down in response to the temperature exceeding a threshold temperature.

Relative to existing technologies, the programmable power modules of this disclosure provide superior flexibility to bias an array of photodetectors in a stable manner in the presence of changes in temperature and/or other operating conditions. Additionally, the programmable power modules of this disclosure can adjust various operational attributes of TIAs that can be used along with the array of photodetectors. Accordingly, a single programmable module described herein can be operational with, and can adjust operation of, different types of APDs having different temperature coefficients and non-linear dependencies on bias voltage and temperature. In sharp contrast, it is noted that in commonplace technologies for biasing an array of APDs, different forms of non-linear dependency are generally addressed much less efficiently. Specifically, those commonplace technologies incorporate both a power supply and a separate dedicated circuitry to control the bias voltage that is supplied to a particular type of APDs present in a LiDAR receiver subsystem. Consequently, changes to the type of APDs present in the LiDAR receiver subsystem can cause changes to that separate dedicated circuitry. Such a lack of versatility and inefficiency is absent in systems, devices, and apparatuses of this disclosure.

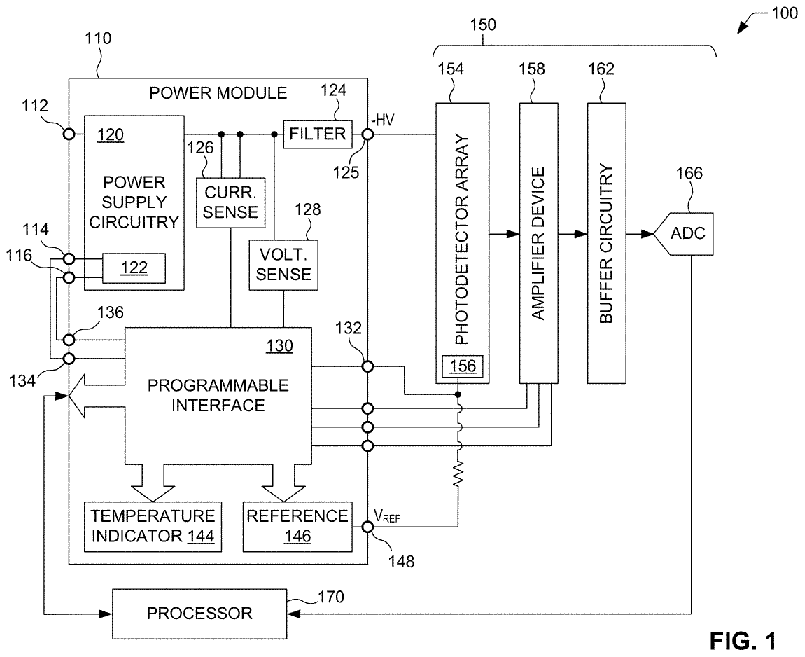

FIG. 1 is a schematic block diagram of an example of a system 100, in accordance with one or more aspects of this disclosure. The system 100 includes a power module 110 that is functionally coupled to a LiDAR receiver subsystem 150. Further, the LiDAR receiver subsystem 150 includes a photodetector array 154, an amplifier device 158, buffer circuitry 162, and an analog-to-digital (A/D) converter 166 (ADC 166). The ADC 166 can be a multi-bit high-speed ADC (rated at giga sample per second (GSPS), for example). In other cases, the ADC 166 can be a time-to-digits converter (TDC) functionally coupled to a comparator device. The ADC 166 can be functionally coupled to a processor 170 that can operate on data from the ADC 166. The photodetectors in the photodetector array 154 can be APDs assembled in a common cathode configuration or a common anode configuration. In some cases, the photodetector array 154 can include silicon-based photodetectors, such as avalanche photodiodes formed as a silicon-based monolithic device. The amplifier device 158 can include multiple TIAs. In one example, the amplifier device 158 can include a quad-channel TIA. Photodetectors in the photodetector array 154 output current and can be connected to respective TIAs in the amplifier device 158. The amplifier device 158 converts the current into voltage. The voltage can be output in a differential configuration. Although a single amplifier device 158 and a single ADC 166 are shown, the disclosure is not limited in that respect. Depending on the number of photodetectors (e.g., APDs) and TIAs present in an implementation of the power module 110, multiple ADCs 166 can receive output from the amplifier device 158. It is noted that, in some cases, a large number of TIAs can be distributed across multiple amplifier devices 158. In such cases, output of the multiple amplifier devices 158 can be multiplexed to the ADC 166 or multiple ADCs 166 can be used.

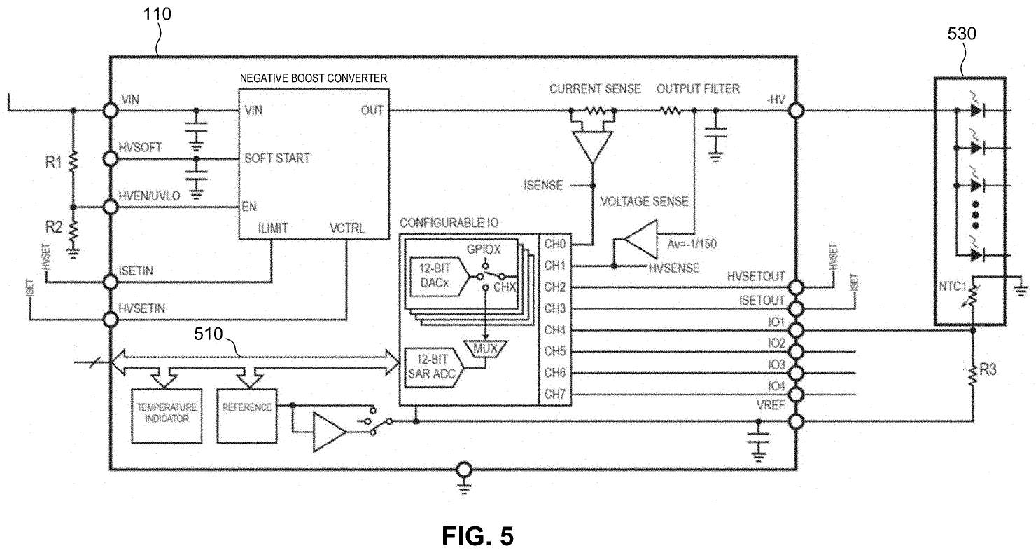

The power module 110 includes power supply circuitry 120 configured to bias the photodetector array 154 by supplying a negative high voltage (denoted by −HV in FIG. 1). The negative high voltage may be referred to as a reverse bias voltage and, in some cases, can range from −300 V to about −375 V. The power supply circuitry 120, however, can supply a wider range of bias voltages ranging from about 0 V to about −600 V. As an example, the power supply circuitry 120 can supply bias voltages in a range from about 0 V to about −400 V. As another example, the power supply circuitry 120 can supply bias voltages in a range from about 0 V to about −500 V. In some cases, the power supply circuitry 120 can include a switching power source 122. The switching power supply can be embodied in a negative boost converter implemented as a current mode DC/DC converter that generates a bias voltage. The power module 110 also includes a filter 124 that filters the bias voltage that is output at a pin 125 (or another type of output port). The filter 124 can be an RC filter (as is shown in FIG. 5, for example). In some cases, the resistor in the RC filter can be a high-voltage resistor and the capacitor can be a ceramic capacitor.

The power supply circuitry 120 also can include a capacitor to bypass a power source pin 112 (referred to as V_{IN}). As a result, a capacitor that is external to the power module 110 may not be required.

The power module 110 includes a programmable interface 130 that renders the power module 110 programmable. The programmable interface 130 includes multiple configurable I/O ports. Each one of the multiple configurable I/O ports can be configured to either supply or receive a signal, where the signal can be either an analog signal or a digital signal. That is, each configurable I/O port can be programmed as an analog input port, an analog output port, a digital input port, or a digital output port. Each configurable I/O port constitutes a channel, and thus, the programmable interface 130 can be referred to as a programmable multi-channel interface.

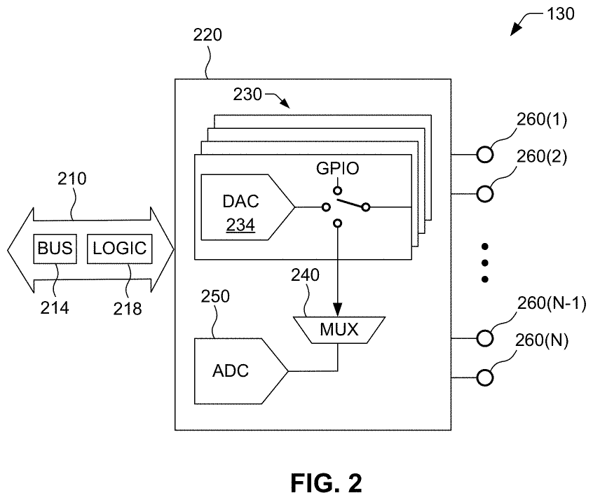

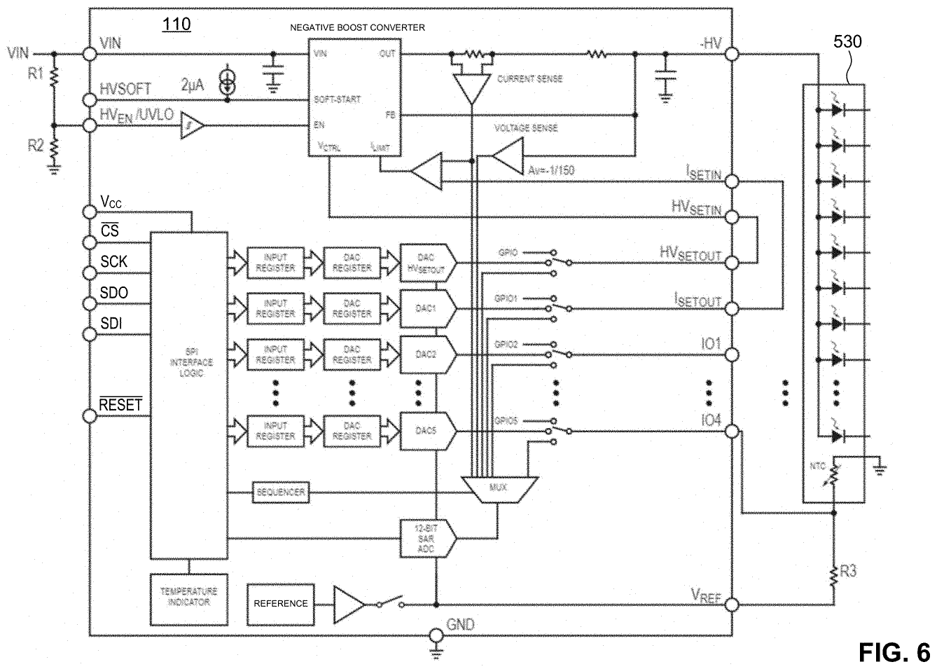

As is illustrated in FIG. 2, the programmable interface 130 can include a serial interface 210, a component assembly 220, and multiple ports including a port 260(1), port 260(2), and continuing up to port 260(N-1), and port 260(N). Here, N>2 because two of the ports 260(1) to 260(N) can be statically configured for current and voltage sensing, as is described herein. The component assembly 220 includes a group of multiple functional elements 230, each including a DAC, a general purpose digital input/output (GPIO) pin, and passthrough pin. In each functional element, each one of the DAC, GPIO, and passthrough terminal is selectable. The component assembly 220 also includes a multiplexer 240 and an ADC 250 (referred to as onboard ADC). The ADC 250 can be a successive approximation (SAR) ADC, a sigma-delta ADC, or similar ADC. In one example, the ADC 250 can be 12-bit SAR ADC. The multiplexer 240 precedes the ADC 250 and can switch selected channels to the ADC. A sequencer can be included in the power module 110 (FIG. 6, for example) for ADC readings. The sequencer is coupled to the multiplexer 240 and can automatically switch the multiplexer 240 to a next selected channel. Further, each functional element in the group of functional elements is connected to a respective one of the multiple ports including the ports 260(1) to 260(N), thus creating a configurable I/O port. It is noted that one or more of port 260(1), port 260(2), and continuing up to port 260(N-1), and port 260(N) can be included in the programmable interface 130 for extensibility purposes, to control operational attributes of prospective implementations of LiDAR receiver subsystems. That is, one or more ports present in the programmable interface 130 can be unused in a particular implementation, but can be used to extend functionality in other implementations. Unused ports can be left floating or can be connected to ground.

The serial interface 210 permits an external processor to set (or program an output of) at least one of port 260(1), port 260(2), . . . , port 260(N-1), and port 260(N) or to readout (read an input from) at least another one of port 260(1), port 260(2), . . . , port 260(N-1), and port 260(N). To that end, the serial interface 210 can include a serial bus 214 and logic 218. In some cases, the serial bus 214 can be a four-line bus according to a Serial Peripheral Interface (SPI) standard. The four lines in the four-line bus are C̅S̅ (chip select), SCK (serial clock), SDO (data output), SDI (data input). In some cases, the serial bus 214 also can include a R̅E̅S̅E̅T̅ line that can be used to reset the power module 110 to a default configuration. Line C̅S̅, SCK, SDI, and R̅E̅S̅E̅T̅ serve as logic input, and line SDO serves as logic output. Data transmitted via the serial bus 214 can be formatted as 16-bit words, in some cases. This disclosure, of course, is not limited in that respect and words having fewer or more bits also can be contemplated. Data can be transferred at rates of up to 20 MHz, for example, and logic levels are determined by V_{CC}. For purposes of illustration, SPI standards specify a synchronous serial communication interface for short-distance communication, primarily in embedded systems. Such a communication interface can operate in half-duplex or sub mode. Operation in full-duplex mode also is contemplated.

The serial bus 214, via SPI ports corresponding to C̅S̅, SCK, SDO, and SDI, for example, can be functionally coupled to the processor 170 (FIG. 1). The processor 170 can send, via the serial bus 214, program code to one or more of the configurable I/O channels corresponding to port 260(1) to port 260(N). The program code can define a datum or a code instruction, and can cause either configuration of a configurable I/O channel or programming of a value of output analog signal from the configuration I/O channel. The processor 170 also can receive data defining a value of an analog signal obtained by the programmable interface 130. Receiving such data can be referred to as readout operation (or readout). Read and write operations afforded by the serial bus 214 can permit sending and receiving program code, respectively. Read and write operations are clocked by the SCK, which can be enabled by the processor 170.

The serial interface 210 also includes or may communicate logic 218. The logic can 218 can interpret data made available in a read operation or a write operation. The logic 210 can be embodied in, or can include multiple registers. In cases the serial interface 210 is embodied in a serial bus according to SPI standards, when C̅S̅ is low, SCK is enabled for shifting SDO data into a register. In addition, SDO is enabled when C̅S̅ is low. When C̅S̅ is high, SDO and SCK are disabled and a programming instruction can be executed. As mentioned, logic levels are determined by V_{CC}. Data can be clocked into an input shift register on the falling edge of the serial clock input. Conversion results from the ADC 250 and register reads (and, in some cases, temperature sensor information) can be provided on SDO as a serial data stream. Bits are clocked out on the rising edge of the SCK input. A most significant bit (MSB) can be placed on the SDO pin on the falling edge of C̅S̅. Because the SCK can idle high or low, a next bit can be clocked out on the first rising edge of SCK that follows a falling edge of SCK while C̅S̅ is low. Data to be written to one or more DACs and control registers included in the multiple registers can be provided on SDI. The data can be clocked into a register, such as a DAC register or a control register, on the falling edge of SCK. Again, logic levels can be determined by V_{CC}.

In some cases, registers included in the logic 218 are 16-bit-wide registers. This disclosure, of course, is not limited in that respect and registers containing a different number of bits also can be contemplated. At least some of those registers correspond to the DAC 234, a GPIO, and the ADC 250, and include input registers. For example, at least one of the ports 260(1) to 260(N) can be configured can be configured as a digital GPIO input pin by programming a GPIO read configuration register or as a digital GPIO pin by programming a GPIO write configuration register. The serial interface 210, via the logic 218, can permits configuring digital GPIO pins using pull-up resistors and pull-down resistors. The logic 218 also can include threshold values involved in various fault protection mechanisms described herein. In addition, or in some cases, one of the multiple registers can include a power-down configuration register to reduce power consumption when particular functionality is not needed. The power-down configuration register also permits enabling a voltage reference 146 included in the power module 110. Enabling the voltage reference causes output of reference voltage from a pin 148. Further, or in some cases, one of the multiple registers can be an ADC sequencer register. By writing to the ADC sequence register, configurable I/O port(s) can be selected for conversion. Furthermore, or in yet other cases, the serial interface 210, via the logic 218, can permit enabling one or more buffer for the configurable I/O ports in order to increase drive strength.

With further reference to FIG. 1, the programmable interface 130 can permit monitoring the filtered output bias voltage supplied by the power module 110 and also the current drawn from the photodetector array 154. By monitoring such voltage and current, the power module 110 can permit assessing an operating state of the photodetector array 154 and can implement fault protection for the power module 110. As is illustrated in FIG. 1, the power module 110 can include a current sense circuit 126 and a voltage sense circuit 128 connected internally to respective channels in the programmable interface 130. Each one of the respective channels can be configured as an ADC output port, and thus receives an analog signal and outputs a digital signal. To that end, a first channel of the respective channels is configured to connect, permanently, the output of the current sense circuit 126 to the multiplexer 240 (FIG. 2) and the ADC 250 (FIG. 2). Additionally, a second channel of the respective channels is configured to connect, permanently, the output of the voltage sense circuitry 128 to the multiplexer 240 and the ADC 250. Here, a permanent connection refers to a connection that is hardwired (via a trace, for example).

The programmable interface 130 also permits adjusting the filtered output bias voltage supplied by the power module 110 during operation. More specifically, that bias voltage can be adjusted based on various operating conditions of the photodetector array 154. As mentioned, one of such operating conditions is temperature. The programmable interface 130 can obtain data indicative of temperature of the photodetector array 154. Based on that temperature, the programmable interface 130 can permit adjusting the bias voltage that the power supply circuitry 120 supplies to the photodetector array 154. By adjusting bias voltage in such a fashion, the power module 110 can cause the photodetector array to operate at a desired level of current gain as temperature changes. Such stability can therefore be achieved with a single element—the power module 110—rather than relying on separate components as is the case in commonplace technologies.

Temperature of the photodetector array 154 can be obtained in several ways. In some cases, a thermistor 156 included in the photodetector array 154 can be used to form a half bridge driven by a reference voltage V_{REF}. While not shown, an end of the thermistor 156 is connected to ground. Additionally, a configurable I/O port 132 of the programmable interface 130 can be configured as an ADC input port. The configurable I/O port 132 can receive a voltage representative of the temperature of the photodetector array 154, and can convert the voltage to a digital signal. As is illustrated in FIG. 1, a voltage reference component 146 included in the power module 110 can supply a reference voltage V_{REF} via the pin 148. In one example, V_{REF} can be equal to about 2.5 V. To supply the reference voltage, the voltage reference component 146 can be set to enabled. It is noted that, in some cases, V_{REF} can be used as a reference source for other components that may be integrated into, or functionally coupled to, the system 100. In scenarios where the voltage reference component 146 is disabled, an external reference can be connected to the pin 148.

Further, a configurable I/O port 134 of the programmable interface 130 can be configured as a digital-to-analog (D/A) converter (DAC) output port. The configurable I/O port 134 can be connected to an input pin 114 of the switching power source 122 (e.g., a negative boost converter). The input pin 114 permits setting (or programming) the negative bias voltage that is supplied by the power supply circuitry 120. As such, based on the temperature, the processor 170 can receive a value indicative of a voltage that is representative of the temperature. The processor 170 can obtain, using that value, a desired bias voltage corresponding to the temperature. The bias voltage can be obtained from a lookup table, for example, in view of the non-linear relationship between current gain and both temperature and bias voltage. The processor 170 can send, via a serial interface (e.g., serial interface 210 (FIG. 2)) that forms part of the programmable interface 130, a programming instruction representative of the desired bias voltage. The configurable I/O port 134 can convert the programming instruction to a defined voltage (which can be referred to as HV_{SET}) and can supply the defined voltage to the input pin 114. In response, the switching power source 122 can supply the desired bias voltage.

In implementations where the photodetector array 140 includes an array of APDs, the power module 110 can permit setting (or programming) a limit to the current that can be drawn from the array of APDs. Such a current limit serves as a fault protection mechanism whereby drawing a current, from the APDs, that exceeds the current limit can cause the power module 110 to power down. Thus, the power module 110 can permit protecting the photodetector array 140 from damage. The power module 110 can permit the configuration of a current limit via a pair of ports consisting of a configurable I/O port 136 that is part of the programmable interface 130 and an input pin 116 connected the switching power source 122 (e.g., a negative boost converter). The input pin 116 can be referred to as I_{SETIN} pin. The configurable I/O port 136 can be programmed as a DAC output port and can supply a voltage representative of a desired value for the current limit. To that end, the configurable I/O port 136 is coupled to the processor 170 via a serial interface (e.g., serial interface 210 (FIG. 2)) that forms part of the configuration interface 130. The configurable I/O port 136 can supply such a voltage to the input pin 116. The input pin 116 can cause the switching power source 122 to set the current limit to the desired value. In one example, the current limit can be about 5.5 mA. The disclosure, however, is not limited in that respect and other current limits can be contemplated.

Further, the programmable interface 130 can permit adjusting various operational attributes of the amplifier device 158. To that end, at least one the multiple configurable I/O ports of the programmable interface 130 can be configured as an DAC output port and can set one or more pins of the amplifier device 158 at respective desired voltages. The processor 170 can set (or program) each one of the respective desired voltages via the serial interface (e.g., serial interface 210 (FIG. 2)) that forms part of the programmable interface 130. Each one of the respective desired voltages in turn can configure an operational attribute of the amplifier device 130. In cases where the amplifier device 158 includes TIAs, the operational attributes include, for example, offset, tilt, clamping, voltage gain, or a combination thereof. Simply as an illustration, FIG. 1 presents three configurable I/O ports connected to the amplifier device 158. More or fewer than three configurable I/O ports can be used to configure the amplifier device 158 in other cases.

The programmable interface 130 is not specific to a particular pin structure (or arrangement) of the amplifier device 158. That is, the programmable interface 130 can adjust operational attributes of the amplifier device 158 regardless of its architecture. Thus, instead of relying of separate components to configure operation of amplifiers devices having different architectures, the power module 110 can permit configuring such amplifiers devices without changing the architecture of the power module 110. Accordingly, not only can the power module 110 bias the photodetector array 154, but the power module 110 also can permit configuring the amplifier device 158.

Other fault protection mechanisms besides over-current and over-voltage protection can be implemented by the power module 110. One of those other mechanisms includes thermal fault protection. To that point, the power module 110 can include a temperature indicator component 144 that can generate a voltage representative of a temperature of the power module 110. Such a voltage can be read using an onboard ADC (e.g., ADC 250 (FIG. 2)) that can be present in the programmable interface 130. Typical temperatures of a die where the power module 110 is packaged can range from −40 ° C. to about 125° C. Temperature can be monitored during operation of the power module 110. The power module 110 can power down in response to the temperature exceeding a threshold temperature Tₜₕ. In response to the temperature exceeding Tₜₕ, the switching power source 122 can stop regulating and the power module 110 can discharge to essentially 0 V. An example of the threshold temperature is 170° C. The disclosure, of course, is not limited in that respect.

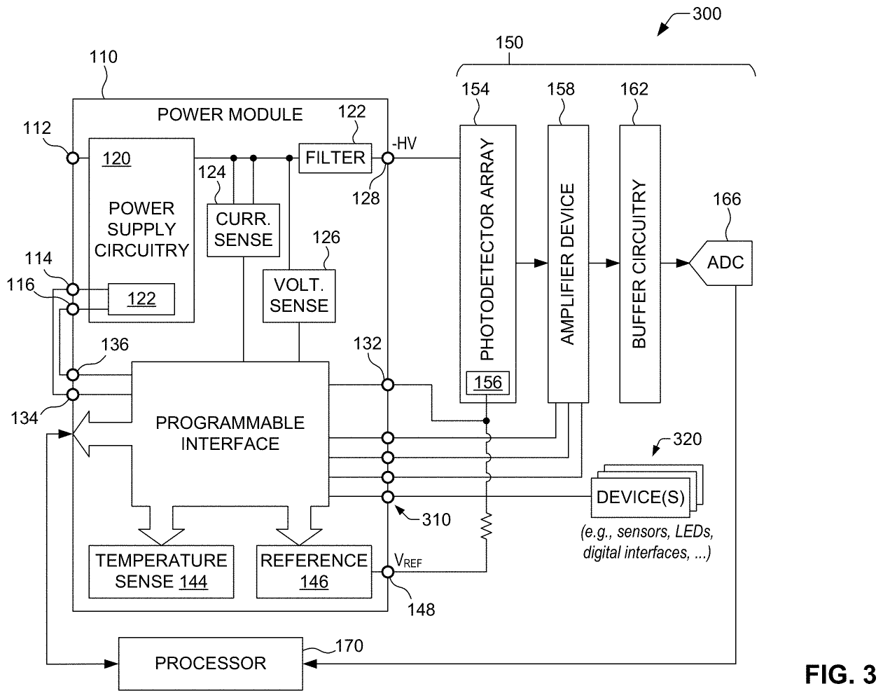

The programmable interface 130 also can be utilized to control operation of other components that may be integrated with, or functionally coupled to, a LiDAR receive system. As an illustration, as is shown in the system 300 in FIG. 3, the programmable interface 130 can include one or multiple configurable ports 310 functionally coupled to one or multiple devices 320. In one example, a particular configurable port of the configurable port(s) 310 can be coupled to an indicator device, such as a lighting device that includes one or multiple light emitting diodes (LEDs). That particular configurable port can provide a signal (analog or digital) to the indicator device in response to the power module 110 supplying a high voltage to the photodetector array 154. The signal can cause the indicator device to be energized and convey an indication of high voltage being present in the LiDAR receiver subsystem 150. The indication can be embodied in light of a particular color, for example. In addition, or as another example, another particular configurable port of the configurable port(s) 310 can be coupled to a temperature sensor that can supply a voltage representative of a temperature. The temperature sensor can be packaged in proximity to the photodetector array 154, and temperature can be representative of the operational temperature of the photodetector array 154. The temperature sensor can substitute the thermistor 144 in some cases.

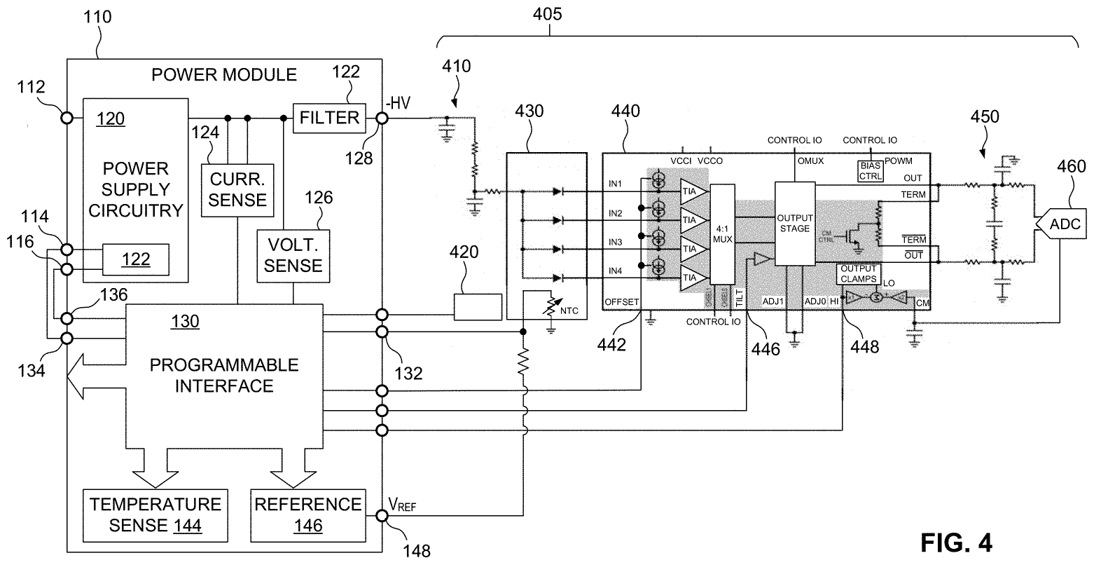

FIG. 4 illustrates an example of a system 400 having the power module 110 integrated with a LiDAR receiver subsystem 405, in accordance with one or more aspects of this disclosure. The LiDAR receiver subsystem 405 includes buffer circuitry 410 that provides additional filtering to the output bias from the power module. The LiDAR receiver subsystem 405 also includes an APD array 430 having four APDs and a thermistor (labeled “NTC”). The APDs are connected in a common-anode configuration. Four APDs are shown simply for purposes of illustration. The disclosure is not limited in that respect, and fewer or more than four APDs can be contemplated in some implementations. As is described herein, a half bridge couples the thermistor to the configurable I/O port 132 of the power module 110. The LiDAR receiver subsystem 405 also includes a temperature sensor 420 assembled in proximity to the APD array 430. The temperature sensor 420 can output a voltage representative of a temperature in proximity of the APD 430. The temperature sensor 420 is connected to a configurable I/O port of the programmable interface 130. That configurable I/O port is configured as an ADC (using an onboard ADC, for example).

The LiDAR receiver subsystem 405 further includes an amplifier device 440 that can receive current from the APD array 430. The amplifier device 440 is a quad-channel device that outputs a differential voltage signal based on the current received from the APD array. The amplifier device includes four TIAs and other components. A first configurable I/O port of the programmable interface 130 is connected to an offset pin 442 in the amplifier device 440. A second configurable I/O port of the programmable interface 130 is connected to a tilt pin 446 in the amplifier device 440. A third configurable I/O port of the programmable interface 130 is connected to a pin 448 that configures clamping in the amplifier device 440.

The differential voltage signal from the amplifier device 440 is output to an ADC 460. The differential voltage signal passes through a buffer circuit 450 onto input pins of the ADC 460.

FIG. 5 is a block diagram of an example of the power module 110 and an APD array 530, in accordance with one or more aspects described herein. Simply as an illustration, the APD array 530 includes more than four APDs. The power module 110 illustrated in FIG. 5 includes programmable interface having eight configurable I/O channels.Channel 0 (CH0) and channel 1 (CH1) statically configured to receive analog signals from current sense and voltage sense, respectively. Channel 2 (CH2) and Channel 3 are each configured as an DAC and permit configuring a bias voltage and a current limit, respectively. The programmable interface has a serial interface 510 in accordance with the SPI standard, for example. The serial interface 510 can be the serial interface 210 (FIG. 2) described herein. FIG. 6 presents a more detailed depiction of the power module 110 and the serial interface shown in FIG. 5. A four-line duplex bus and logic of the serial interface are shown along with various registers and a sequencer coupled to a multiplexer. The programmable interface shown in FIG. 5 and FIG. 6 is an example of the programmable interface 130 described herein.

The power module 110 illustrated in FIG. 5 includes a negative boost converter (which embodies the switching power source 122). Input to the negative boost converter is resistively divided down and connected to an enable pin (denoted HV_{EN}) to implement an undervoltage lockout feature on input (V_{IN}). To avoid multiple transitions when the input is close to a defined threshold level for regulation, a Schmidt trigger can be coupled to the enable pin (as is shown in FIG. 6, for example). The Schmidt trigger has a defined hysteresis (e.g., 60 mV, 80 mV, or similar). The negative boost converter has a soft-start feature.

Because of its programmability, the power module 110 is both backward compatible and forward compatible with LiDAR receiver subsystems. As such, the power module 110 can be integrated into any LiDAR receiver subsystem. To that end, the power module 110 can be packaged in a BGA package, for example, and can then be assembled in a printed circuit board (PCB) that contains a LiDAR receiver subsystem.

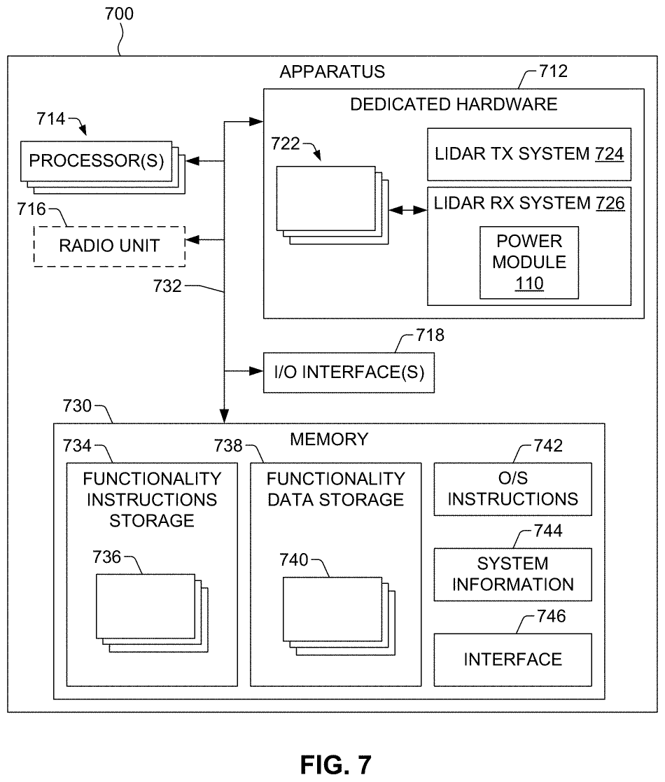

FIG. 7 illustrates an example of an apparatus 700 that can provide various functionalities related to a functional purpose of the apparatus 700 involving navigating, using LiDAR data, within a space having obstacles. The apparatus 700 can obtain such LiDAR data using a LiDAR system that includes the power module 110 described herein. For example, the apparatus 700 can be an autonomous guided vehicle (AGV), an unmanned aerial vehicle (such as a delivery drone or another type of drone), an industrial robot, industrial equipment, or similar apparatuses. Thus, to provide functionality, the apparatus 700 includes computing resources and dedicated hardware 712.

The dedicated hardware 712 includes components 722 that, depending on the functional purpose of the apparatus 700, can include a motor, mechanical parts (e.g., motorized members, wheels, fluid dispenser, and/or an air blower); one or multiple microphones; one or multiple inertial sensors; one or multiple microcontrollers; other types of processors; a combination thereof; or similar components. The apparatus 700 can rely on artificial vision to perform one or more tasks. Thus, as is illustrated in FIG. 7, the dedicated hardware 712 can include a light source device (e.g., laser devices), optic elements, a LiDAR transmitter (TX) system 724, a LiDAR receiver (RX) system 726. The light source device and the optic elements are not depicted for the sake of simplicity. The LiDAR RX system 726 can include a LiDAR receiver subsystem (e.g., LiDAR receiver subsystem 150 (FIG. 1)) and the power module 110 (FIG. 1) coupled thereto. The power module 110 can bias, control, and monitor the LiDAR receiver subsystem, in accordance with aspects of this disclosure.

In order to provide at least some of its functionality, the apparatus 700 can execute one or more software components retained within the apparatus 700. Such component(s) can render the apparatus 700 a particular machine for that functionality, among other functional purposes that the apparatus 700 may have. A software component can be embodied in or can comprise one or more processor-accessible instructions, e.g., processor-readable and/or processor-executable instructions. The one or more processor-accessible instructions that embody a software component can be arranged into one or more program modules, for example, that can be compiled, linked, and/or executed at the apparatus 700 or other computing devices. Generally, such program modules comprise computer code, routines, programs, objects, components, information structures (e.g., data structures and/or metadata structures), etc., that can perform particular tasks (e.g., one or more operations) in response to execution by one or more processors 714 integrated into the apparatus 700.

The various example aspects of the disclosure can be operational with numerous other general purpose or special purpose computing system environments or configurations. Examples of well-known computing systems, environments, and/or configurations that can be suitable for implementation of various aspects of the present disclosure can include personal computers; server computers; laptop devices; handheld computing devices, such as mobile tablets or electronic-book readers (e-readers); wearable computing devices; robots; and multiprocessor systems (such as industrial equipment). Additional examples can include programmable consumer electronics, network personal computers (PCs), minicomputers, mainframe computers, blade computers, programmable logic controllers, distributed computing environments that include any of the above systems or devices, and the like.

As is illustrated in FIG. 7, the apparatus 700 includes one or multiple processors 714, one or multiple input/output (I/O) interfaces 718, one or more memory devices 730 (referred to as memory 730), and a bus architecture 732 (referred to as bus 732) that functionally couples various functional elements of the apparatus 700. The device 460 can include, optionally, a radio unit 716. The radio unit 716 can include one or more antennas and a communication processing unit that can permit wireless communication between the apparatus 700 and another apparatus or computing device, such as a remote computing device and/or a remote sensor). The bus 732 can include at least one of a system bus, a memory bus, an address bus, or a message bus, and can permit the exchange of information (data and/or signaling) between the processor(s) 714, the I/O interface(s) 718, and/or the memory 730, or respective functional elements therein. In some cases, the bus 732 in conjunction with one or more internal programming interfaces 746 (also referred to as interface 746) can permit such exchange of information. In cases where the processor(s) 714 include multiple processors, the apparatus 700 can utilize parallel computing.

The I/O interface(s) 718 can permit communication of information between the apparatus 700 and an external device, such as another apparatus or a computing device. Such communication can include direct communication or indirect communication, such as the exchange of information between the apparatus 700 and the external device via a network or elements thereof. The I/O interface(s) 718 can include one or more of network adapter(s), peripheral adapter(s), and display unit(s). Such adapter(s) can permit or facilitate connectivity between the external device and one or more of the processor(s) 714 or the memory 730. For example, the peripheral adapter(s) can include a group of ports, which can include at least one of parallel ports, serial ports, Ethernet ports, V.35 ports, or X.21 ports. In certain aspects, the parallel ports can comprise General Purpose Interface Bus (GPM), IEEE-1284, while the serial ports can include Recommended Standard (RS)-232, V.11, Universal Serial Bus (USB), FireWire or IEEE-1394.

The I/O interface(s) 718 can include a network adapter that can functionally couple the apparatus 700 to one or more remote computing devices or sensors (not depicted in FIG. 7) via one or more traffic and signaling pipes that can permit or otherwise facilitate the exchange of traffic and/or signaling between the apparatus 700 and such one or more remote computing devices or sensors. Such network coupling provided at least in part by the network adapter can be implemented in a wired environment, a wireless environment, or both. The information that is communicated by the network adapter can result from the implementation of one or more operations of a method in accordance with aspects of this disclosure. The I/O interface(s) 718 can include more than one network adapter in some cases.

In addition, or in some cases, depending on the architectural complexity and/or form factor the apparatus 700, the I/O interface(s) 718 can include a user-device interface unit that can permit control of the operation of the apparatus 700, or can permit conveying or revealing operational conditions of the apparatus 700. The user-device interface can be embodied in, or can include, a display unit. The display unit can include a display device that, in some cases, has touch-screen functionality. In addition, or in some cases, the display unit can include lighting devices (e.g., LEDs) that can convey an operational state of the apparatus 700.

The bus 732 can have at least one of several types of bus structures, depending on the architectural complexity and/or form factor the apparatus 700. The bus structures can include a memory bus or a memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like.

The apparatus 700 can include a variety of computer-readable media. Computer-readable media can be any available media (transitory and non-transitory) that can be accessed by a computing device or another type of apparatus or equipment having computing resources. In one aspect, computer-readable media can include computer non-transitory storage media (or computer-readable non-transitory storage media) and communications media. Examples of computer-readable non-transitory storage media include any available media that can be accessed by the apparatus 700, including both volatile media and non-volatile media, and removable and/or non-removable media. The memory 730 can include computer-readable media in the form of volatile memory, such as random access memory (RAM), and/or non-volatile memory, such as read-only memory (ROM).

The memory 730 can include functionality instructions storage 734 and functionality data storage 738. The functionality instructions storage 734 can include computer-accessible instructions that, in response to execution (by at least one of the processor(s) 714, for example), can implement one or more functionalities of the apparatus 700. The computer-accessible instructions can embody, or can include, multiple software components and can be part of multiple components 736. Execution of at least one component components 736 can implement one or more of the functionalities of the apparatus 700. Such execution can cause a processor (e.g., one of the processor(s) 714) that executes the at least one component to carry out at least a portion of the one or more functionalities.

A processor of the processor(s) 714 that executes at least one of the components 736 can retrieve data from or retain data in one or more memory elements 740 in the functionality data storage 738 in order to operate in accordance with the functionality programmed or otherwise configured by the components 736. The one or more memory elements 740 may be generically referred to as data. Data retained in the memory element(s) 740 can include at least one of program code, data structures, or similar.

The interface 746 (e.g., a serial interface, an application programming interface) can permit or facilitate communication of data between two or more the components 736 within the functionality instructions storage 734. The data that can be communicated by the interface 746 can result from implementation of one or more operations in a method that can be performed by the apparatus 700. In some cases, one or more of the functionality instructions storage 734 or the functionality data storage 738 can be embodied in or can comprise removable/non-removable, and/or volatile/non-volatile computer storage media.

At least a portion of at least one of components 736 or the data 740 can program or otherwise configure one or more of the processors 714 to operate at least in accordance with functionality of the apparatus 700. One or more of the processor(s) 714 can execute at least one of the components 736, and also can use at least a portion of the data in the functionality data storage 738 in order to provide functionality of the apparatus 700. In some cases, the functionality instructions storage 734 can embody, or can include, a computer-readable non-transitory storage medium having computer-accessible instructions that, in response to execution, cause at least one processor (e.g., one or more of the processor(s) 714) to perform a group of operations comprising operations corresponding to one or several functionalities of the apparatus 700.

In addition, the memory 730 can include processor-accessible instructions and information (e.g., data and/or program code) that permit or facilitate the operation and/or administration (e.g., upgrades, software installation, any other configuration, or the like) of the apparatus 700. Accordingly, as illustrated, the memory 730 can include a memory storage 742 (referred to as operating system (O/S) instructions 742) that contains one or more program modules that embody or include one or more operating systems, such as Windows operating system, Unix, Linux, Symbian, Android, Chromium, and substantially any O/S suitable for mobile computing devices or tethered computing devices. In one aspect, the operational and/or architectural complexity of the apparatus 700 can dictate a suitable O/S. The memory 730 also includes system information storage 744 having data and/or program code that permits or facilitates the operation and/or administration of the apparatus 700. Elements of the O/S instructions 742 and the system information storage 744 can be accessible or can be operated on by at least one of the processor(s) 714.

It should be recognized that while the functionality instructions 734 and other executable program components, such as the O/S instructions 742, are illustrated herein as discrete blocks, such software components can reside at various times in different memory components of the apparatus 700, and can be executed by at least one of the processor(s) 714.

The apparatus 700 can include a power supply (not shown), which can power up components or functional elements within the apparatus 700. The power supply can be a rechargeable power supply, e.g., a rechargeable battery, and it can include one or more transformers to achieve a power level suitable for the operation of the apparatus 700 and components, functional elements, and related circuitry therein. In some cases, the power supply can be connected to a conventional power grid to recharge and ensure that the apparatus 700 can be operational. To that end, the power supply can use an I/O interface (e.g., one of the interface(s) 718, for example) to connect to the conventional power grid. In addition, or in other cases, the power supply can include an energy conversion component, such as a solar panel, to provide additional or alternative power resources or autonomy for the apparatus 700.

In some scenarios, the apparatus 700 can operate in a networked environment by utilizing connections to one or more remote computing devices and/or sensors (not depicted in FIG. 7). As an illustration, a remote computing device can be a personal computer, a portable computer, a server, a router, a network computer, a peer device, and so on. As described herein, connections (physical and/or logical) between the apparatus 700 and a remote computing device or sensor can be made via one or more traffic and signaling pipes (not depicted in FIG. 7), which can include wired link(s) and/or wireless link(s) and several network elements (such as routers or switches, concentrators, servers, and the like) that form a local area network (LAN), a wide area network (WAN), and/or other networks (wireless or wired) having different footprints.

Numerous other aspects emerge from the foregoing detailed description and annexed drawings. Those aspects are represented by the following Clauses.

Clause 1 includes a device, where the device includes first circuitry that supplies a bias voltage to a photodetector array; and a programmable interface comprising a serial interface and multiple configurable ports, wherein each one of the multiple configurable ports is configured as one of a digital-to-analog converter (DAC) output port, an analog-to-digital converter (ADC) input port, a digital output port, or a digital input port, wherein the serial interface is configured to receive program code defining a control voltage that causes the first circuitry to supply the bias voltage; and wherein a first configurable port of the multiple configurable ports is connected to the first circuitry and is configured as a first DAC output port that outputs the control voltage to the power module.

A Clause 2 includes Clause 1, where a second configurable port of the multiple configurable ports is configured as a first ADC input port that receives a first voltage representative of a temperature of the photodetector array and outputs a digital value representative of the temperature.

A Clause 3 includes any of the preceding Clauses 1 or 2, where a second configurable port of the multiple configurable ports is connected to an amplifier device that is connected to the photodetector array, the second configurable port being configured as a second DAC output port that outputs a control analog signal to set an operational attribute of the amplifier device.

A Clause 4 includes any of the preceding Clauses 1 to 3, where the amplifier device comprises a transimpedance amplifier (TIA), and where the operational attribute is one of an offset of the TIA, a tilt of the TIA, or clamping level of the TIA.

A Clause 5 includes any of the preceding Clauses 1 to 4, where the serial interface comprises a serial bus according to a serial peripheral interface (SPI) standard.

A Clause 6 includes any of the preceding Clauses 1 to 5, and further includes second circuitry configured to filter the bias voltage that is supplied.

A Clause 7 includes any of the preceding Clauses 1 to 6, where the first circuitry comprises a negative boost converter configured to supply the bias voltage, the negative boost converter having a first pin configured to receive the control voltage.

A Clause 8 includes any of the preceding Clauses 1 to 7, where the serial interface is configured to receive second program code defining a second control voltage that causes the negative boost converter to limit a current drawn from the photodetector array.

A Clause 9 includes any of the preceding Clauses 1 to 8, where the negative boost converter comprises a second pin configured to receive the second control voltage, and where a second configurable port of the multiple configurable ports is connected to the second pin and is configured as a second DAC output port that outputs the second control voltage to the second pin.

A Clause 10 includes any of the preceding Clauses 1 to 9, and further includes a temperature indicator configured to output a voltage indicative of a temperature of the device.

A Clause 11 includes any of the preceding Clauses 1 to 10, where the device is assembled in a ball grid array (BGA) package.

A Clause 12 includes any of the preceding Clauses 1 to 11, where the defined voltage has a value in a range from about 0 V to about −600 V.

A Clause 13 includes a system, where the system includes a power module including: circuitry that supplies a bias voltage; and a programmable interface comprising a serial interface and multiple configurable ports, wherein each one of the multiple configurable ports is configured as one of a digital-to-analog converter (DAC) output port, an analog-to-digital converter (ADC) input port, a digital output port, or a digital input port; a photodetector array coupled to the power module and configured to receive the bias voltage; and an amplifier device coupled to the photodetector array.

A Clause 14 includes Clause 13, where the serial interface is configured to receive program code defining a control voltage that causes the circuitry to supply the bias voltage; and where a first configurable port of the multiple configurable ports is connected to the circuitry and is configured as a first DAC output port that outputs the control voltage to the power module.

A Clause 15 that includes any of the preceding Clauses 13 or Clause 14, and further includes a processor functionally coupled to the serial interface, the processor being configured to send program code to the programmable interface, the program code causing one or more of configuration of at least one of the multiple configurable ports or programming of an output analog signal from a configuration port of the multiple configurable ports.

A Clause 16 that includes any of the preceding Clauses 13 to 15, and further includes an ADC coupled to the amplifier device.

A Clause 17 that includes any of the preceding Clauses 13 to 16, where the photodetector array comprises an array of avalanche photodiodes, and where supplying the bias voltage to the photodetector array comprises applying the bias voltage to each avalanche photodiode in the array of avalanche photodiodes.

A Clause 18 that includes any of the preceding Clauses 13 to 17, where each avalanche photodiode in the array of the avalanche photodiodes is a silicon-based monolithic device, and wherein the bias voltage is applied to a cathode of each avalanche photodiode.

A Clause 19 includes an apparatus, where the apparatus includes dedicated hardware having a LiDAR subsystem that includes: a power module including: circuitry that supplies a bias voltage; and a programmable interface comprising a serial interface and multiple configurable ports, wherein each one of the multiple configurable ports is configured as one of a digital-to-analog converter (DAC) output port, an analog-to-digital converter (ADC) input port, a digital output port, or a digital input port; a photodetector array coupled to the power module and configured to receive the bias voltage; and an amplifier device coupled to the photodetector array.

A Clause 20 that includes Clause 19, and further includes a processor functionally coupled to the serial interface, the processor being configured to send program code to the programmable interface, the program code causing one or more of configuration of at least one of the multiple configurable ports or programming of an output analog signal from a configuration port of the multiple configurable ports.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, a special purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the term “component” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general purpose computer, a special purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

What has been described above includes examples of one or more aspects of the disclosure. It is, of course, not possible to describe every conceivable combination of components or methodologies for purposes of describing these examples, and it can be recognized that many further combinations and permutations of the present aspects are possible. Accordingly, the aspects disclosed and/or claimed herein are intended to embrace all such alterations, modifications and variations that fall within the spirit and scope of the detailed description and the appended claims. Furthermore, to the extent that one or more of the terms “includes,” “including,” “has,” “have,” or “having” is used in either the detailed description or the claims, such term is intended to be inclusive in a manner similar to the term “comprising” as “comprising” is interpreted when employed as a transitional word in a claim.

What is claimed is:

1. A device, comprising:
first circuitry that supplies a bias voltage to a photodetector array; and
a programmable interface comprising a serial interface and multiple configurable ports, wherein each one of the multiple configurable ports is configured as one of a digital-to-analog converter (DAC) output port, an analog-to-digital converter (ADC) input port, a digital output port, or a digital input port;
wherein the serial interface is configured to receive program code defining a control voltage that causes the first circuitry to supply the bias voltage; and
wherein a first configurable port of the multiple configurable ports is connected to the first circuitry and is configured as a first DAC output port that outputs the control voltage to the power module.

2. The device of claim 1, wherein a second configurable port of the multiple configurable ports is configured as a first ADC input port that receives a first voltage representative of a temperature of the photodetector array and outputs a digital value representative of the temperature.

3. The device of claim 1, wherein a second configurable port of the multiple configurable ports is connected to an amplifier device that is connected to the photodetector array, the second configurable port being configured as a second DAC output port that outputs a control analog signal to set an operational attribute of the amplifier device.

4. The device of claim 3, wherein the amplifier device comprises a transimpedance amplifier (TIA), and wherein the operational attribute is one of an offset of the TIA, a tilt of the TIA, or clamping level of the TIA.

5. The device of claim 1, wherein the serial interface comprises a serial bus according to a serial peripheral interface (SPI) standard.

6. The device of claim 1, further comprising second circuitry configured to filter the bias voltage that is supplied.

7. The device of claim 6, wherein the first circuitry comprises a negative boost converter configured to supply the bias voltage, the negative boost converter having a first pin configured to receive the control voltage.

8. The device of claim 7, wherein the serial interface is configured to receive second program code defining a second control voltage that causes the negative boost converter to limit a current drawn from the photodetector array.

9. The device of claim 7, wherein the negative boost converter comprises a second pin configured to receive the second control voltage, and
wherein a second configurable port of the multiple configurable ports is connected to the second pin and is configured as a second DAC output port that outputs the second control voltage to the second pin.

10. The device of claim 7, further comprising a temperature indicator configured to output a voltage indicative of a temperature of the device.

11. The device of claim 10 assembled in a ball grid array (BGA) package.

12. The device of claim 7, wherein the defined voltage has a value in a range from about 0 V to about −600 V.

13. A system, comprising:
a power module including:
circuitry that supplies a bias voltage; and
a programmable interface comprising a serial interface and multiple configurable ports, wherein each one of the multiple configurable ports is configured as one of a digital-to-analog converter (DAC) output port, an analog-to-digital converter (ADC) input port, a digital output port, or a digital input port;
a photodetector array coupled to the power module and configured to receive the bias voltage; and
an amplifier device coupled to the photodetector array.

14. The system of claim 13, wherein the serial interface is configured to receive program code defining a control voltage that causes the circuitry to supply the bias voltage; and
wherein a first configurable port of the multiple configurable ports is connected to the circuitry and is configured as a first DAC output port that outputs the control voltage to the power module.

15. The system of claim 13, further comprising a processor functionally coupled to the serial interface, the processor being configured to send program code to the programmable interface, the program code causing one or more of configuration of at least one of the multiple configurable ports or programming of an output analog signal from a configuration port of the multiple configurable ports.

16. The system of claim 15, further comprising an ADC coupled to the amplifier device.

17. The system of claim 13, wherein the photodetector array comprises an array of avalanche photodiodes, and wherein supplying the bias voltage to the photodetector array comprises applying the bias voltage to each avalanche photodiode in the array of avalanche photodiodes.

18. The system of claim 17, wherein each avalanche photodiode in the array of the avalanche photodiodes is a silicon-based monolithic device, and wherein the bias voltage is applied to a cathode of each avalanche photodiode.

19. An apparatus, comprising:
dedicated hardware having a LiDAR subsystem that includes:
a power module including:
circuitry that supplies a bias voltage; and
a programmable interface comprising a serial interface and multiple configurable ports, wherein each one of the multiple configurable ports is configured as one of a digital-to-analog converter (DAC) output port, an analog-to-digital converter (ADC) input port, a digital output port, or a digital input port;
a photodetector array coupled to the power module and configured to receive the bias voltage; and
an amplifier device coupled to the photodetector array.

20. The apparatus of claim 19, further comprising a processor functionally coupled to the serial interface, the processor being configured to send program code to the programmable interface, the program code causing one or more of configuration of at least one of the multiple configurable ports or programming of an output analog signal from a configuration port of the multiple configurable ports.
